(19) United States
(12) Patent Application Publication
(10) Pub. No.: US 2008/0172864 A1
(43) Pub. Date: Jul. 24, 2008

(54) TERMINAL CRIMPING APPARATUS

(75) Inventors: Satoshi YAGI, Makinohara-shi (JP); Shigeharu SUZUKI, Makinohara-shi (JP); Tetsuro IDE, Makinohara-shi (JP); Hideto KUMAKURA, Makinohara-shi (JP); Kenji SUZUKI, Makinohara-shi (JP)

Correspondence Address: SUGHRUE-265550, 2100 PENNSYLVANIA AVE. NW, WASHINGTON, DC, 20037-3213, US

(73) Assignee: YAZAKI CORPORATION, Tokyo (JP)

(21) Appl. No.: 11/969,976

(22) Filed: Jan. 7, 2008

(30) Foreign Application Priority Data
Jan. 18, 2007 (JP) 2007-009136

(51) Int. Cl. H01R 43/04

(52) U.S. Cl. 29/753; 29/761

(57) ABSTRACT

A terminal crimping apparatus includes an anvil for supporting a metal terminal including a base plate portion for placing an electric wire thereon and a pair of crimping piece portions extending upwardly respectively from opposite side edges of the base plate portion, and a crimper which includes a press-fastening portion having a generally arch-shape formed of two arc-shaped surfaces which are opposed to the anvil. The anvil and the crimper cooperate to press-fasten the crimping piece portions for crimping the crimping piece portions to the electric wire placed on the metal terminal. A radius R of curvature of each of the two arc-shaped surfaces of the press-fastening portion of the crimper is determined so as to satisfy the following formula: 0.25 W≦R≦0.27 W, where W represents a predetermined width of a crimped portion to be formed.

### BACKGROUND

This invention relates to a terminal crimping apparatus for crimping a metal terminal (having a pair of crimping piece portions (barrel) extending upwardly respectively from opposite side edges of a base plate portion thereof to a core wire of an electric wire.

There is known one conventional terminal crimping apparatus for crimping a terminal to a core wire of an electric wire, in which crimping piece portions of the terminal are pressed by an anvil and a crimper, and are press-fastened to the core wire (see, for example, JP-A-2002-373755 (FIG. 1)).

As shown in FIG. 8, the apparatus disclosed in JP-A-2002-373755 comprises the anvil 4 for holding the metal terminal 6, and the crimper 3 located above the anvil 4 and having a pair of press-fastening (or press-fastening) portions 2 and 2 formed on a surface thereof facing the anvil 4. In this apparatus, a core wire 7 is placed on and received in the metal terminal 6 supported on the anvil 4, and in this condition the crimper 3 is moved downward, so that crimping piece portions 6a and 6a (jointly assuming a generally U-shaped cross-section) are pressed between the crimper 3 and the anvil 4, and are press-fastened to the core wire 7.

In recent years, with a compact design of electronic equipments, there have been proposed metal terminals for connection to a very thin electric wire including a core wire having a cross-sectional area of 0.08 to 0.13 mm². In such very thin electric wires, a copper alloy harder than conventionally-used annealed copper and brass is used as a material for the core wire in view of a wire strength. However, the conventional crimping apparatus is not designed for such a thin, hard electric wire, and therefore when the metal terminal is crimped to the very thin electric wire with this conventional crimping apparatus, there is a fear that there may develop variations in the amount of biting of the crimping piece portions of the metal terminal and also in the height and width of a wire crimped portion. And besides, when such variations develop, the crimped shape becomes unstable, which leads to a fear that a clamping force and an electrical performance may be lowered. Furthermore, in the case of the very thin electric wire, the connection performance is particularly adversely affected by the above variations.

Therefore, there has been proposed a terminal crimping method designed for a very thin electric wire (see, for example, JP-A-2006-49117 (FIGS. 3 and 4)). In the method disclosed in JP-A-2006-49117, dimensions of a metal terminal and dimensions (a height and a width of a crimped portion) of the crimped metal terminal are decreased according to the down-sizing of the electric wire, and the crimped terminal is produced, and by doing so, the optimum range is determined. And, in the case of a very thin electric wire including a high-strength core wire, the press-fastening is effected without contact with the core wire, and by doing so, a sufficient tensile strength of the core wire is secured even when the terminal is crimped to the core wire.

However, in the above conventional crimping technique for the very thin electric wire, when variations develop in the amount of biting of the crimping piece portions of the metal terminal and the height (crimp height) and width (crimp width) of the crimped portion, the crimped shape becomes unstable, which leads to a fear that the clamping force and the electrical performance may be lowered.

When the metal terminal is crimped to the very thin electric wire, there develop the reduced contact area due to the increased crimp height caused by the overlapping of one crimping piece portion of the metal terminal on the other crimping piece portion, the reduced strength of the conductor due to the reduced crimp height caused by the bottoming of one crimping piece portion, etc. Therefore, there has been encountered a problem that the force (strength) of clamping of the metal terminal to the electric wire is lowered, so that the mechanical and electrical performances are lowered.

### SUMMARY

Therefore, it is an object of this invention to provide a terminal crimping apparatus in which when a terminal is crimped to a very thin electric wire, there is obtained a wire crimped portion which is made stable in shape, and is excellent in mechanical and electrical performances.

The above object of the present invention has been achieved by the following construction.

(1) A terminal crimping apparatus, comprising:

an anvil for supporting a metal terminal including a base plate portion for placing an electric wire thereon and a pair of crimping piece portions extending upwardly respectively from opposite side edges of the base plate portion; and

a crimper which includes an opening portion and a press-fastening portion having a generally arch-shape formed of two arc-shaped surfaces which are opposed to the anvil,

wherein the anvil and the crimper cooperate to press-fasten the crimping piece portions for crimping the crimping piece portions to the electric wire placed on the metal terminal; and

wherein a radius R of curvature of each of the two arc-shaped surfaces of the press-fastening portion of the crimper is determined so as to satisfy the following formula:

0.25 W≦R≦0.27 W

where W represents a predetermined width of a crimped portion of the metal terminal to be formed; and

wherein a width of the opening portion of the crimper is equal to the predetermined width of a crimped portion.

(2) The terminal crimping apparatus of the above Paragraph (1), wherein the pair of crimping piece portions are crimped to the electric wire having a cross-sectional area of 0.08 to 0.13 mm².

(3) The terminal crimping apparatus of the above Paragraph (1), wherein the metal terminal is crimped to the electric wire made of a copper alloy.

In the construction of the above Paragraph (1), when the crimping piece portions are crimped to the very thin electric wire, the height and width of the wire crimped portion are made stable, so that the shape of the wire crimped portion is made stable. The inventors of the present invention have made an extensive study of the relation between the radius R of curvature of the arch-shaped surfaces of the press-fastening portion of the crimper and the predetermined width of the crimped portion to be formed, and have found that when the formula, 0.25 W≦R≦0.27 W, is established, the shape of the wire crimped portion is made stable.

When R≦0.24 W is provided, it has been found that the arch-shape of the crimper is not properly formed, and a boundary portion between the arc-shaped surfaces is not formed into a sharp edge, and therefore is defective as a pressing die.

When R≧0.28 W is provided, it has been found that one crimping piece portion overlaps the other crimping piece portion at the crimped portion, so that the crimped portion has the defective shape, and mechanical and electrical performances of the crimped portion are lowered.

Incidentally, the predetermined width W of the crimped portion to be formed is equal to a width W of that portion of a crimper opening disposed on a straight line passing through centers of curvature of the pair of press-fastening portions formed respectively by the pair of arc-shaped surfaces.

The terminal crimping apparatus of the above Paragraph (1) is particularly effective for crimping the metal terminal to the core wire having a cross-sectional area of 0.08 to 0.13 mm², and in this case the shape of the wire crimped portion is made stable.

Also, the terminal crimping apparatus of the above Paragraph (1) is particularly effective for crimping the metal terminal to the core wire made of a copper alloy which is harder than conventionally-used annealed copper and brass, and in this case the shape of the wire crimped portion is made stable.

The invention is effective in the case where the metal terminal is crimped to the core wire made, for example, of a copper alloy containing tin (Sn).

In the present invention, the wire crimped portion can be formed into the predetermined height and width, and the shape of the wire crimped portion is made stable, and therefore there can be obtained the wire crimped portion which is not lowered in mechanical and electrical characteristics, and therefore is excellent in these characteristics.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a front-elevational view of one preferred embodiment of a terminal crimping apparatus of the present invention;

FIG. 2 is an exploded, perspective view showing a crimper and an anvil used in the crimping apparatus of FIG. 1;

FIG. 3 is an enlarged view of an important portion of the terminal crimping apparatus of FIG. 1;

FIG. 4 is an enlarged view of an important portion of the crimper;

FIGS. 5A to 5D are views showing the process of crimping a metal terminal to an electric wire;

FIGS. 6A to 6E are cross-sectional views of crimped portions formed respectively by crimpers of different shapes;

FIG. 7 is an enlarged view of an important portion of a crimper; and

FIG. 8 is an enlarged view of an important portion of a conventional crimping apparatus.

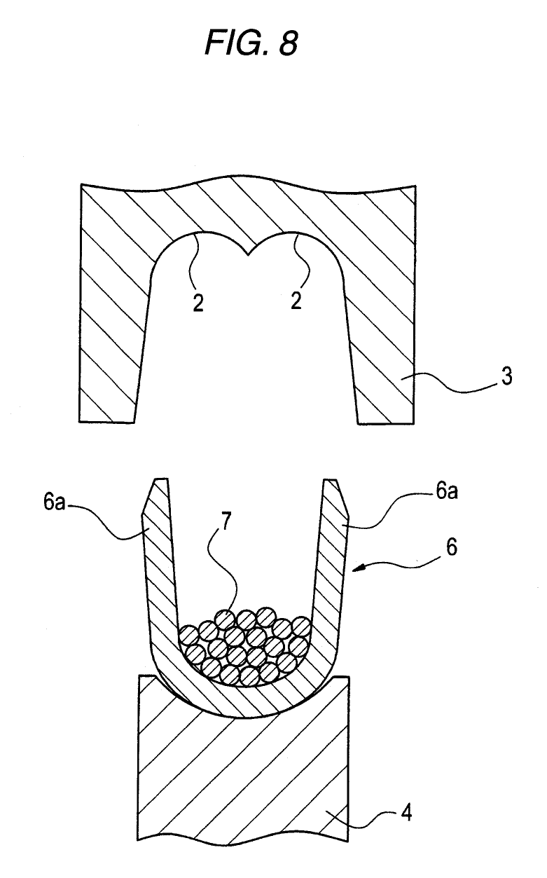

### DETAILED DESCRIPTION OF EXEMPLARY EMBODIMENTS

A preferred embodiment of the present invention will now be described with reference to the accompanying drawings.

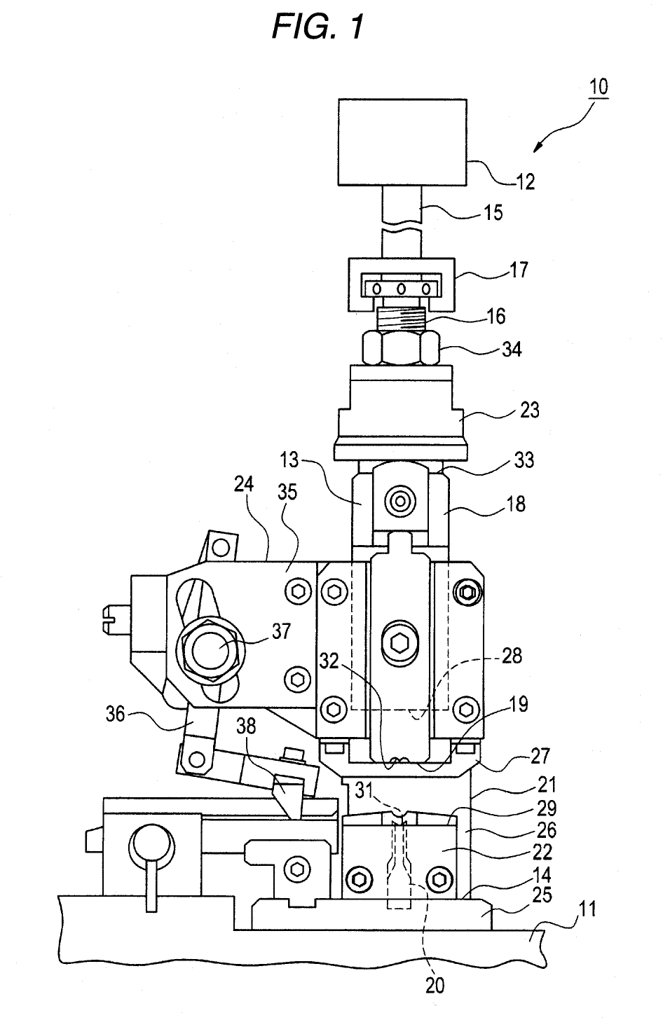

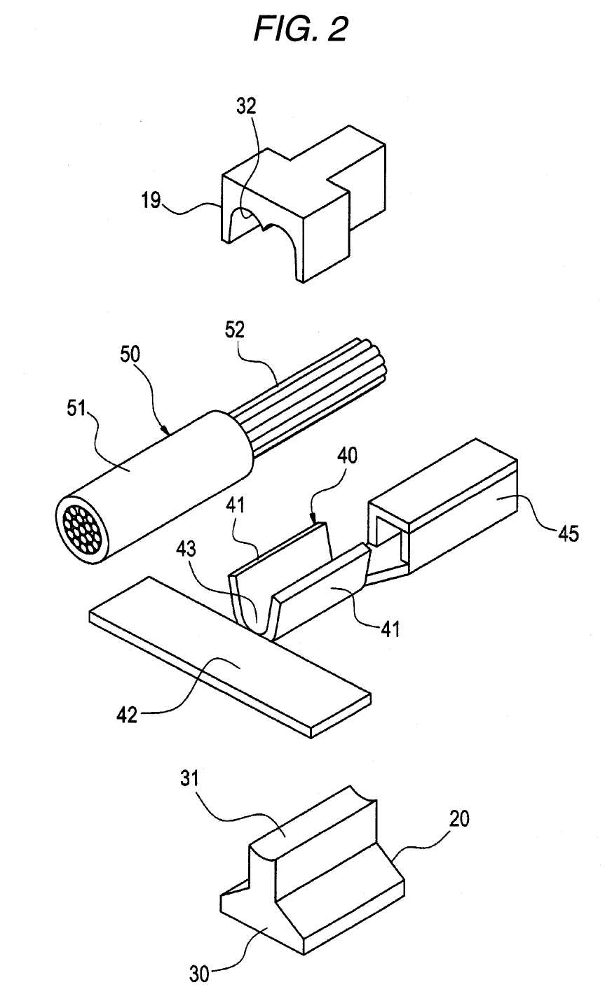

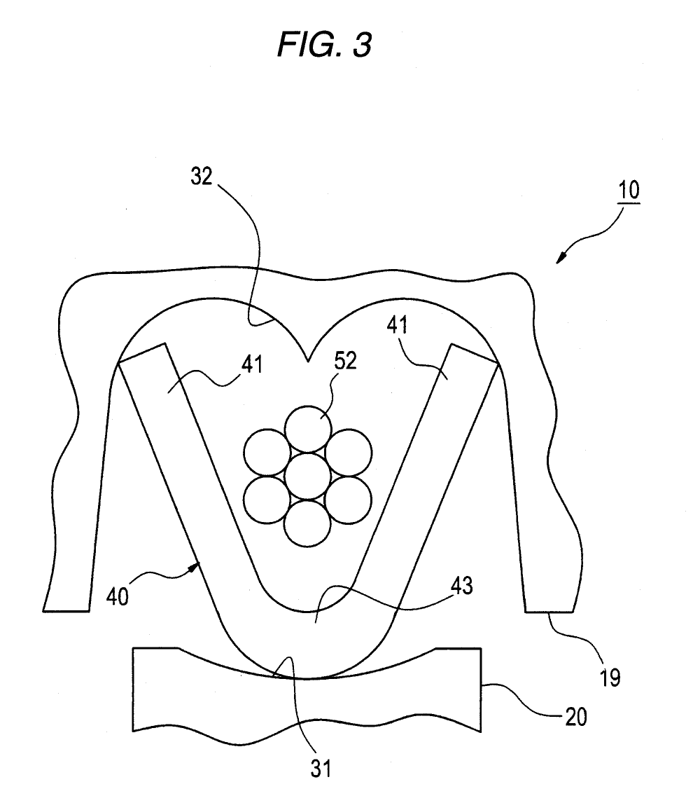

FIG. 1 is a front-elevational view of one preferred embodiment of a terminal crimping apparatus of the invention, FIG. 2 is a perspective view showing a crimper and an anvil used in the crimping apparatus of FIG. 1, and FIG. 3 is an enlarged view of an important portion of the crimping apparatus of FIG. 1.

As shown in FIGS. 1 and 2, the crimping apparatus 10 of the invention comprises a base 11 placed on a floor or the like, a drive source 12, and a crimping applicator 13 for crimpingly connecting the metal terminal 40 to an electric wire 50.

The base 11 has a flat portion 14 which is generally flat in a horizontal direction. The crimping applicator 13 is placed and supported on the base 11.

The drive source 12 comprises a servomotor (not shown), a drive shaft 15 for transmitting a driving force, and a hook 17 engaged with a disk portion (not shown) of a shank 16. A rotational motion of the servomotor is converted into a linear motion via a piston-crank mechanism so as to move a ram 18 upward and downward. Instead of the servomotor, a hydraulic cylinder having a piston rod connected to the shank 16 in directly-driving relation or other suitable drive unit may be used.

The crimping applicator 13 includes the crimper (terminal crimping die) 19, and the anvil 20. The crimper 19 is moved downward to press-deform (press-fasten) crimping piece portions 41 of the metal terminal 40, thereby crimping the crimping piece portions 51 to the electric wire 50.

Various forms of metal terminals can be used as the metal terminal 40 which is to be press-deformed by the crimping applicator 13. For example, a female metal terminal having a box-like electrical contact portion, a male terminal having a tab-like electrical contact portion, a joint metal terminal for connecting two wires together, etc., can be used.

The metal terminal 40 is formed by forming an electrically-conductive sheet into a predetermine shape and then by bending it. The metal terminal 40 includes a sheath clamping (crimping) piece portion 42 adapted to be press-clamped (or crimped) to a sheath 51 of the electric wire 50, a curved base plate portion 43 on which that portion of a core wire (conductor) 52 of the electric wire 50 from which the sheath 51 has been removed is adapted to be placed, the pair of crimping piece portions 41 extending upwardly respectively from opposite side edges of the base plate portion 43, and a electrical contact portion 45 of a square tubular shape.

The pair of crimping piece portions 41 of the metal terminal 40 are press-deformed or bent inwardly by the downward movement of the crimper 19, and therefore are crimped to the core wire 52 of the electric wire 50 to be electrically connected thereto.

A rotational motion of the servomotor is converted into a linear motion by the piston/crank mechanism so as to move the ram 18 (holding the crimper 19) upward and downward, thereby moving the crimper 19 upward and downward. There is provided a control portion (not shown) for controlling the upward and downward movement of the ram 18, and this control portion effects various controls including the acceleration, deceleration, crimping movement and standing-by of the ram 18.

The crimping applicator 13 comprises a frame 21, a holder 22 having the anvil 20, the ram 18 supported on the frame 21, a ram bolt 23 threadedly engaged with the ram 18 so as to enable the upward and downward movement of the ram 18, the shank 16 threadedly engaged with the ram bolt 23, and a terminal feed unit 24.

The frame 21, when viewed from the side thereof, has a generally recumbent U-shape, and includes a mounting portion 25 on which the holder 22 is mounted, an upwardly-extending support post portion 26, and a ram support portion 27.

The frame 21 is placed on the flat portion 14 of the base 11, and is fixed thereto to bolts and nuts (not shown). The frame 21 may be integrally fixed to the base 11.

The ram support portion 27 is connected to an upper end portion of the support post portion 26 extending upwardly from the mounting portion 25 on which the holder 22 is mounted. A space for guiding the ram 18 is formed in the ram support portion 27, and the ram 18 is slidably fitted in this space.

The anvil 20 for the placing of the metal terminal 40 thereon is embedded in the holder 22. The holder 22 has a flat surface 29 opposed to both of the crimper 19 and a lower end surface 28 of the ram 18. Namely, the flat surface 29 is disposed substantially perpendicularly to both of the direction of movement of the ram 18 and a direction of movement of the crimper 19.

The anvil 20 is received and held in the holder 22, and in this condition the holder 22 is mounted on the mounting portion 25 of the frame 21. The anvil 20 is held in the holder 22, with its bottom plate 30 disposed in intimate contact with a bottom wall of the holder 22, and therefore the anvil 20 can support the metal terminal 40 thereon without being shaken.

The anvil 20 abuts against the base plate portion 43 of the metal terminal 40, and upon application of a pressing force from the crimper 19, the anvil 20 cooperates with the crimper 19 to press-deform the crimping piece portions 41 into a predetermined shape.

The anvil 20 has a contact surface for contact with the base plate portion 43 of the metal terminal 40, and a curved surface 31 is formed on this contact surface.

The ram 18 has a generally rectangular parallelepiped shape. The ram 18 is supported in the ram support portion 27 so as to move upward and downward in the vertical direction. A longitudinal axis of the ram 18 extends in the direction of movement thereof, that is, in the vertical direction. The lower end surface 28 of the ram 18 is flat, and is perpendicular to the direction of movement of the ram 18.

The crimper 19 is provided at a lower half portion of the ram 18 in opposed relation to the anvil 20. The ram 18 is supported in the ram support portion 27 so as to move upward and downward, and therefore the crimper 19 can be moved toward and away from the anvil 20. In other words, the crimper 19 is moved toward and away from the anvil 20 in accordance with the downward and upward movement of the ram 18.

The crimper 19 is in the form of a generally rectangular parallelepiped-shaped plate, and press-fastening portions (press-fastening portions) 32 of a generally arch-shape are formed at an inner surface of the crimper 19 opposed to the anvil 20. Each press-fastening portion 32 is formed into a curved shape or generally arc-shape so that the press-fastening portions 32 can press-deform the crimping piece portions 41 of the metal terminal 40 into a predetermined shape.

The ram bolt 23 is threaded into a threaded hole formed in an upper end surface 33 of the ram 18, and therefore is mounted on the ram 18. By thus mounting the ram bolt 23 on the ram 18, the ram 18 can be moved upward and downward.

The shank 16 has a hollow cylindrical shape. The disk portion formed at one end of the shank 16 is connected to the hook 17 of the drive source 12, and a screw portion formed at the other end of the shank 16 is threaded in a screw hole in the ram bolt 23. Namely, the shank 16 transmits a driving force of the drive source 12 to the ram 18 via the ram bolt 23 so as to move the crimper 19 upward and downward.

The amount of threading of the shank 16 in the screw hole of the ram bolt 23 can be adjusted, and therefore the shank 16 is mounted on the ram bolt 23 in such a manner that the position of the shank 16 relative to the ram bolt 23 can be changed. When the position of the shank 16 relative to the ram bolt 23 is changed by adjusting the amount of threading of the shank 16 in the screw hole of the ram bolt 23, the distance (gap) between the anvil 20 and the crimper 19 is also changed.

The shank 16 has a nut 34 threaded on an externally-threaded portion thereof, and the nut 34 is tightened, with the shank 16 threaded in the screw hole of the ram bolt 23, and by doing so, the ram bolt 23 and the shank 16 can be fixed to each other.

The terminal feed unit 24 comprises a cam (not shown) provided at a side portion of the ram 18, a connecting rod (not shown) adapted to abut against the cam to be moved in the horizontal direction, a lever support portion 35 receiving the connecting rod therein, a crank-like lever 36 fitted in the lever support portion 35, a pivot shaft 37 supporting the lever 36 in a manner to allow a pivotal movement of the lever 36, and a terminal feed claw 38 provided at a distal end portion of the lever 36.

In the terminal feed unit 24, the cam is moved downward by the driving force of the drive source 12, and at this time the connecting rod abuts at its one end against the cam, and is pushed to be moved in the horizontal direction, so that the other end portion of the connecting rod is brought into abutting engagement with the lever 36, and the lever 36 is pivotally moved about the pivot shaft 37. As a result, the terminal feed claw 38 is engaged in a feed hole in a chain-like strip (not shown) having a series of metal terminals 40, and moves this chain-like strip in a terminal feeding direction to feed one metal terminal at a time to a crimping position.

As shown in FIG. 3, the base plate portion 43 of the metal terminal 40 is placed on the curved surface 31 of the anvil 20, and the core wire 52 of the electric wire 50 is placed on the base plate portion 43. Then, when the ram 18 is moved downward, the anvil 20 and the crimper 19 cause the core wire 52 of the electric wire 50 to be held between the pair of crimping piece portions 41, and the crimping piece portions 41 are press-deformed by the press-fastening portions 32 of the crimper 19.

The crimper 19 includes the press-fastening portions 32 of a generally arch-shape open toward the anvil 20, and is movable upward and downward. The anvil 20 is disposed below the crimper 19, and is formed into such a shape as to be fitted in a recess formed by the press-fastening portions 32 of the crimper 19. The upper surface of the anvil 20 serves as a crimping surface, and the curved surface 31 for the placing of the metal terminal 40 thereon is formed on this crimping surface.

The metal terminal 40 is placed on the curved surface 31, with the core wire 52 received in a crimping portion of a generally U-shaped cross-section (formed by the crimping piece portions 41 and the base plate portion 43), and then the crimper 19 is moved downward to press the metal terminal 40 in the vertical direction. At this time, while distal (upper) ends of the crimping piece portions 41 gradually move upwardly in sliding contact with an inner surface of the recess in the crimper 19, the crimping piece portions 41 are pressed to be bent inwardly at their upper end portions to embrace the core wire 52, and are press-fastened to the core wire 52 in biting relation thereto.

The press-fastening portions 32 of the crimper 19 are formed by a pair of symmetrically-disposed right and left arc-shaped surfaces, respectively, and a boundary portion between the arc-shaped surfaces projects toward the anvil. That portion of each press-fastening portion 32 disposed close to the open side (lower side) of the crimper 19 serves as a guide surface for guiding the corresponding crimping piece portion 41 to the arc-shaped surface.

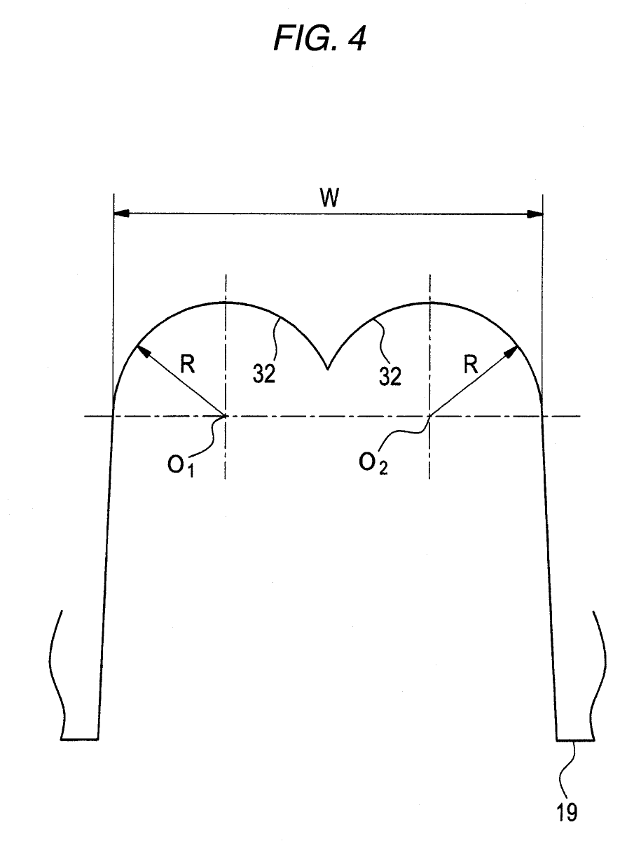

As shown in FIG. 4, each of the press-fastening portions 32 includes the arc-shaped surface with a radius R of curvature, and the guide surface extending from this arc-shaped surface. The radius R of curvature of the press-fastening portion 32 is so determined as to satisfy the following formula:

0.25 W≦R≦0.27 W

where W represents a predetermined width of a crimped portion.

The predetermined width W of the crimped portion to be formed is equal to a width W of that portion of the crimper opening (or the recess defining the press-fastening portions 32) disposed on a straight line passing through centers O₁ and O₂ of curvature of the pair of press-fastening portions 32 and 32.

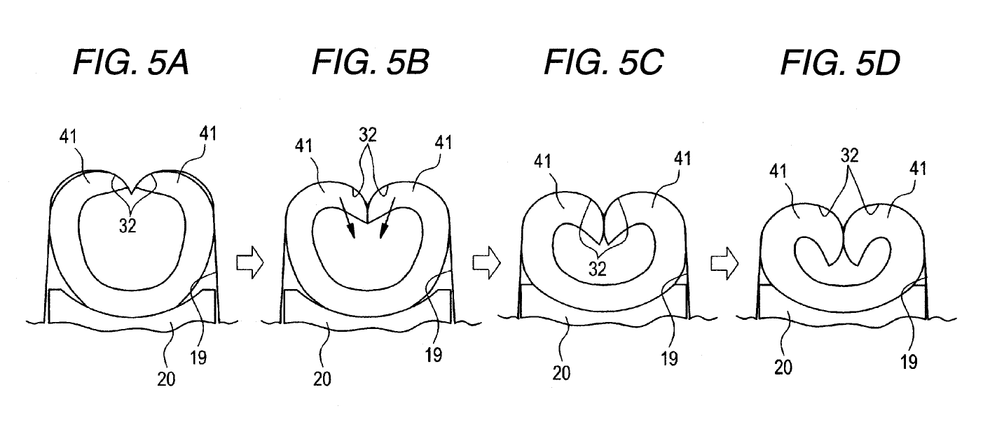

FIGS. 5A to 5D show the process of crimping the crimping piece portions 41 of the metal terminal 40 to the core wire 52. Referring to the process of crimping the crimping piece portions 41 to the core wire 52, the crimping piece portions 41 of the metal terminal 40 begin to be bent by the crimper 19 and the anvil 20 as shown in FIG. 5A, and then the crimping piece portions 41 are further bent, so that their distal ends are directed downwardly as shown in FIG. 5B. Then, the crimping piece portions 41 are further bent, so that their distal ends are brought into abutting engagement with each other as shown in FIG. 5C, and then the crimping piece portions 41 are further bent, so that their distal ends bite into the core wire 52, and therefore the crimping piece portions 41 are press-fastened to the core wire 52.

The relation between the radius R of curvature of each press-fastening portion 32 of the crimper 19 and the predetermined width W of the crimped portion is determined as described above, and therefore in the process step shown in FIG. 5B, the pressing force is exerted in such a direction that the distal ends of the crimping piece portions 41 can be more easily directed downward. And besides, in the process step shown in FIG. 5D, the right and left crimping piece portions 41 bite uniformly into the core wire 52. As a result, the wire crimped portion is formed into the predetermined height and width, and therefore has the stable shape.

Particularly in the case of using a very thin electric wire with the core wire 52 having a cross-sectional area of 0.08 to 0.13 mm² and made of a material (such as a copper alloy) harder than that used in conventional electric wires, there can be obtained the wire crimped portion which is made stable in shape and also has the stable performances (that is, is not lowered in mechanical and electrical performances).

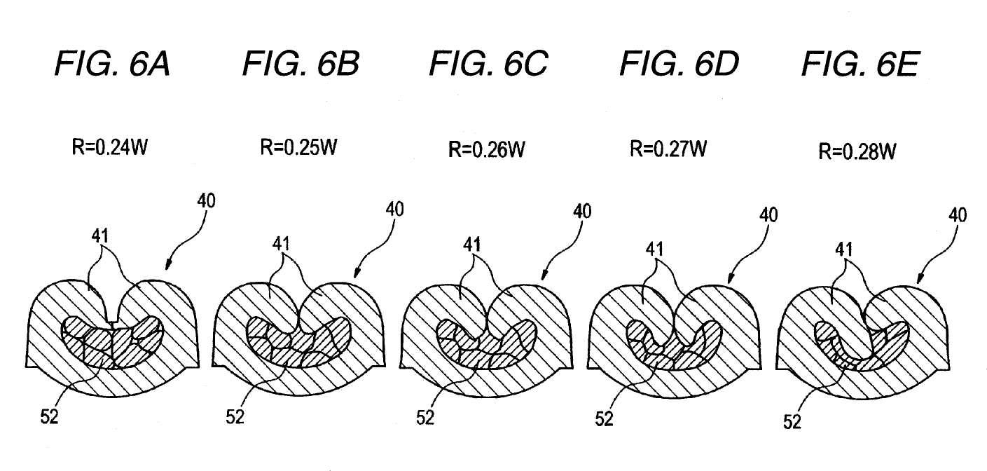

FIGS. 6A to 6E show results obtained when crimping piece portions 41 were crimped to core wires 52, while gradually changing the relation between a radius R of curvature of each press-fastening portion 32 and a predetermined width W of a crimped portion. The core wire 52 used here for each electric wire was made of a copper alloy containing tin (Sn) (The Sn content: 0.3%), and the cross-sectional area of the core wire was 0.13 mm². Incidentally, similar results were obtained also with electric wires each having a core wire whose cross-sectional area was 0.08 mm².

FIG. 6A shows the results obtained when the crimping piece portions 41 were crimped to the core wire 52 by the press-fastening portions 32 so shaped as to provide the relation, R=0.24 W. In this condition, the height of the crimped portion was larger than a predetermined value, so that the area of contact between the crimping piece portions 41 with the core wire 52 was smaller than a predetermined value. And besides, the amount of biting of the crimping piece portions 41 into the core wire 52 was insufficient, so that a wire clamping force was lowered.

FIG. 6B shows the results obtained when the crimping piece portions 41 were crimped to the core wire 52 by the press-fastening portions 32 so shaped as to provide the relation, R=0.25 W. In this condition, the wire crimped portion had the predetermined height and width.

FIG. 6C shows the results obtained when the crimping piece portions 41 were crimped to the core wire 52 by the press-fastening portions 32 so shaped as to provide the relation, R=0.26 W. In this condition, the wire crimped portion had the predetermined height and width.

FIG. 6D shows the results obtained when the crimping piece portions 41 were crimped to the core wire 52 by the press-fastening portions 32 so shaped as to provide the relation, R=0.27 W. In this condition, the wire crimped portion had the predetermined height and width.

FIG. 6E shows the results obtained when the crimping piece portions 41 were crimped to the core wire 52 by the press-fastening portions 32 so shaped as to provide the relation, R=0.28 W. In this condition, the right and left crimping piece portions 41 failed to bite uniformly into the core wire 52 such that one crimping piece portion 41 overlapped the other crimping piece portion 41. Therefore, the height of the crimped portion was lower than the predetermined value, so that a mechanical strength of the wire crimped portion was lowered.

The results of FIGS. 6A to 6E as well as results of very thin electric wires with a cross-sectional area of 0.08 mm² are shown in Table 1.

TABLE 1

| | Cross- | | | | | | |
|---|---|---|---|---|---|---|---|
| | sectional | | Height | Width W | | | |
| | area of | Radius R | H of | of | | | |
| | core | of | crimped | crimped | Mechanical | Electrical | Overall |
| Sample | wire | curvature | portion | portion | strength | strength | evaluation |
| Comparative. | 0.13 mm² | 0.24 W | X(high) | X(narrow) | ◯ | X | X |
| Example 1 | | | | | | | |
| Example 1 | | 0.25 W | ◯ | ◯ | ◯ | ◯ | ◯ |
| Example 2 | | 0.26 W | ◯ | ◯ | ◯ | ◯ | ◯ |
| Example 3 | | 0.27 W | ◯ | ◯ | ◯ | ◯ | ◯ |
| Comparative. | | 0.28 W | X(low) | X(wide) | X | ◯ | X |
| Example 2 | | | | | | | |
| Comparative. | 0.08 mm² | 0.24 W | X(high) | X(narrow) | ◯ | X | X |
| Example 3 | | | | | | | |
| Example 4 | | 0.25 W | ◯ | ◯ | ◯ | ◯ | ◯ |
| Example 5 | | 0.26 W | ◯ | ◯ | ◯ | ◯ | ◯ |
| Example 6 | | 0.27 W | ◯ | ◯ | ◯ | ◯ | ◯ |
| Comparative. | | 0.28 W | X(low) | X(wide) | X | ◯ | X |
| Example 4 | | | | | | | |

◯: within predetermined range
X: outside predetermined range and improper

It will be appreciated from the foregoing that when the crimper 19 having the press-fastening portions 32 of the arch-shape satisfying the relation, 0.25 W≦R≦0.27 W, is used, the wire crimped portion is formed into the predetermined height and width, and thus the wire crimped portion has such a stable shape that the mechanical and electrical performances are not lowered.

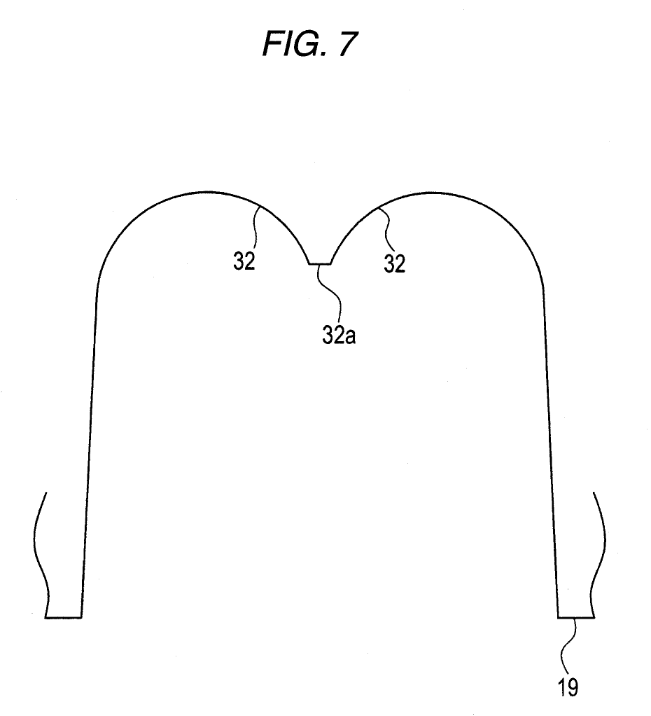

When there is used the crimper 19 having the press-fastening portions 32 of such an arch-shape that R is 0.24 W or less, a boundary portion between the arc-shaped surfaces is not formed into a sharp edge, but is formed into a narrow surface 32a as shown in FIG. 7, and each press-fastening portion 32 is not formed into the proper arch-shape. As a result, the defective pressing by the crimper 19 occurs, and the area of contact between the crimping piece portions 41 and the core wire 52 at the wire crimped portion is reduced, and also the amount of biting of the crimping piece portions 41 into the core wire 52 is insufficient, so that the wire clamping force (strength) of the wire crimped portion is lowered.

When there is used the crimper 19 having the press-fastening portions 32 of such an arch-shape that R is 0.28 W or more, the height of the wire crimped portion is lower than the predetermined value, so that the mechanical strength of the wire crimped portion is lowered.

As described above, in the terminal crimping apparatus 10 of the above embodiment, the shape of the wire crimped portion can be made stable, and in the condition in which the crimping piece portions 41 of the metal terminal 40 are crimped to the core wire 52 of the electric wire 50, the contact area as well as the contacting load can be made stable.

Namely, the reduced contact area due to the increased crimp height caused by the overlapping of one crimping piece portion 41 of the metal terminal 40 on the other crimping piece portion 41, the reduced strength of the core wire 52 due to the reduced crimp height caused by the bottoming of one crimping piece portion 41, etc., can be prevented.

Therefore, the uniform and proper biting of the crimping piece portions 41 of the metal terminal 40 into the core wire 52 can be easily achieved, and the stable crimped condition of each crimping piece portion 41 relative to the core wire 52 can be obtained. Therefore, without actually preparing sample crimpers, the desired crimper can be designed while accurately predicting the crimping performance, and the mechanical and electrical performances can be enhanced, and the time, labor and costs required for the design and evaluation can be reduced.

The present invention is not limited to the above embodiment, and various modifications, improvements, etc., can be suitably made. Furthermore, the material, dimensions, numerical value, form, number, disposition, etc., of each of the constituent elements of the above embodiment are arbitrary, and are not limited in so far as the invention can be achieved.

The present application is based on Japan Patent Application No. 2007-009136 filed on Jan. 18, 2007, the contents of which are incorporated herein for reference.

What is claimed is:

1. A terminal crimping apparatus, comprising:
an anvil for supporting a metal terminal including a base plate portion for placing an electric wire thereon and a pair of crimping piece portions extending upwardly respectively from opposite side edges of the base plate portion; and
a crimper which includes an opening portion and a press-fastening portion having a generally arch-shape formed of two arc-shaped surfaces which are opposed to the anvil,
wherein the anvil and the crimper cooperate to press-fasten the crimping piece portions for crimping the crimping piece portions to the electric wire placed on the metal terminal; and
wherein a radius R of curvature of each of the two arc-shaped surfaces of the press-fastening portion of the crimper is determined so as to satisfy the following formula:
0.25 W≦R≦0.27 W
where W represents a predetermined width of a crimped portion of the metal terminal to be formed; and
wherein a width of the opening portion of the crimper is equal to the predetermined width of a crimped portion.

2. The terminal crimping apparatus according to claim 1, wherein the pair of crimping piece portions are crimped to the electric wire having a cross-sectional area of 0.08 to 0.13 mm².

3. The terminal crimping apparatus according to claim 1, wherein the metal terminal is crimped to the electric wire made of a copper alloy.
